(19) United States
(12) Patent Application Publication
(10) Pub. No.: US 2024/0225952 A1
(43) Pub. Date: Jul. 11, 2024

(54) SEXUAL STIMULATION ADULT MASSAGER

(71) Applicant: HYTTO PTE. LTD.

(72) Inventors: Dan LIU, Guangzhou (CN); Jilin QIU, Guangzhou (CN)

(21) Appl. No.: 18/152,690

(22) Filed: Jan. 10, 2023

(51) Int. Cl. A61H 19/00

(52) U.S. Cl. CPC A61H 19/44; A61H 2201/013; A61H 2201/0153; A61H 2201/0192; A61H 2201/105; A61H 2201/1215; A61H 2201/123; A61H 2201/1481; A61H 2201/1669; A61H 2201/169

(57) ABSTRACT

Embodiments of the present disclosure disclose a sexual stimulation adult massager. The sexual stimulation adult massager includes a hollow housing, a motor assembly, a transmission structure, a sliding assembly, and a movement structure. The transmission structure includes a screw rod with a spiral groove, operatively connected to a motor rotating shaft of a motor of the motor assembly. The sliding assembly includes a screw slider coupled to the screw rod of the transmission structure to convert a rotational motion of the screw rod into a translation motion of the screw slider. The movement structure is operatively connected to the screw slider through the slot of the hollow housing to produce a reciprocating motion. The movement structure includes a connecting assembly adapted to connect to an adult toy to provide sexual stimulation to a user due to the reciprocating motion. A controller is configured to control the operation of the motor.

### TECHNICAL FIELD

The present disclosure relates to sexual pleasure devices and, more particularly relates, to the massagers or toys for engaging and sexually stimulating the human body, particularly the penis and the vagina.

### BACKGROUND

Sexual stimulating massage is used to develop and enhance sexual arousal in the human body. A sexual stimulator creates sexual stimulation by engaging the stimulator in sensitive erogenous zones of the human body for sexual pleasure. For instance, the sexual stimulator can be used for creating sexual pleasure in various body parts such as the vulva, clitoris, vagina, penis, and the like.

A variety of sexual stimulation massagers such as sex toys, adult toys, dildos, etc., are available in the market for performing a variety of functions, ranging from medical therapy to erotic stimulation. The stimulating massagers are designed to provide massaging effects through several operations like vibration, expansion and contraction, suction, etc. However, the movement of these sexual stimulation massagers is fairly limited. Also, the currently available stimulating massagers are not designed specifically to accommodate the physiologies of different kinds of users while stimulating more than one area of the body simultaneously and providing independent user control of the stimulation. Also, it is noted that the conventional stimulating massagers have a short service life and need to be replaced after a relatively short time due to the design of the movement mechanisms.

Therefore, there exists a need for a sexual stimulation adult massager with an improved mechanism of movement to enhance sexual arousal to the user's body.

### SUMMARY

Various embodiments of the present disclosure provide a sexual stimulation adult massager for providing sexual stimulation and enhancing sexual arousal to the user's body. The sexual stimulation adult massager has been designed for the unisex application.

In an embodiment, a sexual stimulation adult massager is disclosed. The sexual stimulation adult massager has a hollow housing provided with a slot in an outer shell of the hollow housing. The sexual stimulation adult massager includes a motor assembly, a transmission structure, and a sliding assembly disposed within the hollow housing and a movement structure configured outside the hollow housing. The transmission structure includes a screw rod with a spiral groove, operatively connected to a motor rotating shaft of a motor of the motor assembly. The sliding assembly includes a screw slider coupled to the screw rod of the transmission structure to convert a rotational motion of the screw rod into a reciprocating motion of the screw slider. The movement structure is operatively connected to the screw slider through the slot of the hollow housing for achieving the reciprocating motion. The movement structure includes a connecting assembly adapted to connect to an adult toy to provide sexual stimulation to a user due to the reciprocating motion. A power source is configured to provide electric power to the motor for rotating the motor rotating shaft. A controller is configured to control the operation of the motor.

### BRIEF DESCRIPTION OF THE FIGURES

The following detailed description of illustrative embodiments is better understood when read in conjunction with the appended drawings. To illustrate the present disclosure, exemplary constructions of the disclosure are shown in the drawings. However, the present disclosure is not limited to a specific device, or a tool and instrumentalities disclosed herein. Moreover, those in the art will understand that the drawings are not to scale.

FIG. 1 illustrates a perspective view of a sexual stimulation adult massager, in accordance with an embodiment of the present disclosure;

FIG. 2A illustrates a schematic representation of an internal configuration of a sexual stimulation adult massager in a contracted condition, in accordance with an embodiment of the present disclosure;

FIG. 2B illustrates a schematic representation of the internal configuration of the sexual stimulation adult massager of FIG. 2A in an expanding condition;

FIG. 3 illustrates a schematic representation of an arrangement of a motor assembly and a transmission structure along a same axis, in accordance with an embodiment of the present disclosure;

FIG. 4 is a block diagram of a controller for controlling the operation of one or more components of a sexual stimulation massage apparatus, in accordance with an embodiment of the present disclosure;

FIG. 5A illustrates a perspective view of a sexual stimulation adult massager, in accordance with an embodiment of the present disclosure;

FIG. 5B illustrates a perspective view of a sexual stimulation adult massager, in accordance with another embodiment of the present disclosure;

FIG. 6 illustrates a schematic representation of the operation of a screw slider of the sexual stimulation adult massager of FIGS. 5A and 5B;

FIG. 7 illustrates a schematic representation of a transmission part of a sexual stimulation adult massager, in accordance with another embodiment of the present disclosure;

FIG. 8 illustrates a schematic representation of a motor assembly of a sexual stimulation adult massager, in accordance with another embodiment of the present disclosure;

FIG. 9 illustrates a schematic representation of a mounting structure of a sexual stimulation adult massager, in accordance with another embodiment of the present disclosure;

FIGS. 10A and 10B illustrate a schematic representation of mounting an adult toy on a sexual stimulation adult massager, in accordance with another embodiment of the present disclosure; and

FIG. 11 illustrates a schematic representation of mounting an adult toy on a sexual stimulation adult massager, in accordance with another embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Various examples of the present disclosure provide a sexual stimulation adult massager. In an embodiment, a sexual stimulation adult massager includes a hollow housing, a motor assembly, a transmission structure, a sliding assembly, and a movement structure. The transmission structure includes a screw rod with a spiral groove, operatively connected to a motor rotating shaft of a motor of the motor assembly. A power source is configured to provide electric power to the motor for rotating the motor rotating shaft. A controller is configured to control the operation of the motor. The sliding assembly includes a screw slider coupled to the screw rod of the transmission structure to convert a rotational motion of the screw rod into a translation motion of the screw slider. The movement structure is operatively connected to the screw slider through the slot of the hollow housing to produce a reciprocating motion. The movement structure includes a connecting assembly adapted to connect to an adult toy to provide sexual stimulation to a user due to the reciprocating motion. The reciprocating motion of the adult toy may be used on one or more areas of the user's body such as penis, vulva, clitoris, vagina, and the like.

In one embodiment, the adult toy includes at least one of stimulation massager, a vibrator, a heater, a dildo, and a suction cup. Introducing these stimulating components within the movement structure may cause sexual stimulation to the vagina and clitoris of the female body and the penis of the male body. The stimulation effect includes, but is not limited to, a thrusting stimulation, a vibration stimulation, a temperature stimulation, a rotation stimulation, a sucking stimulation, an expansion and contraction stimulation, a telescopic stimulation, and an impact stimulation. A controller controls the rotational speed of the motor by controlling the power supplied to the motor. The electric power is supplied to the motor through a power source. The power source may be an electrical connection or a battery. The controller controls the rotational speed of the motor based on the input provided by the user. The input is provided through a knob positioned on the body or through a wireless connection. With respect to the speed of the rotation of the motor rotating shaft of the motor, the frequency of reciprocation of the movement structure changes. For example, in one predefined program, the reciprocation frequency of the movement structure may operate in the range of 1000 to 3000 cycles/min.

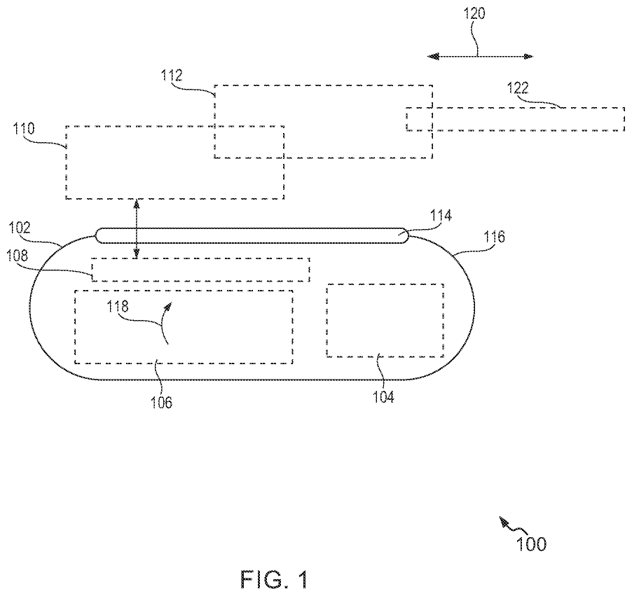

Various example embodiments of the present disclosure are described hereinafter with reference to FIG. 1 to FIG. 11.

FIG. 1 illustrates a perspective view of a sexual stimulation adult massager, in accordance with an embodiment of the present disclosure. The sexual stimulation adult massager 100 is designed for providing sexual stimulation and enhancing sexual arousal to the user's body. Specifically, the sexual stimulation adult massager 100 is designed to accommodate the physiologies of different kinds of users while simultaneously stimulating more than one area of the users' body and providing independent user control of the stimulation.

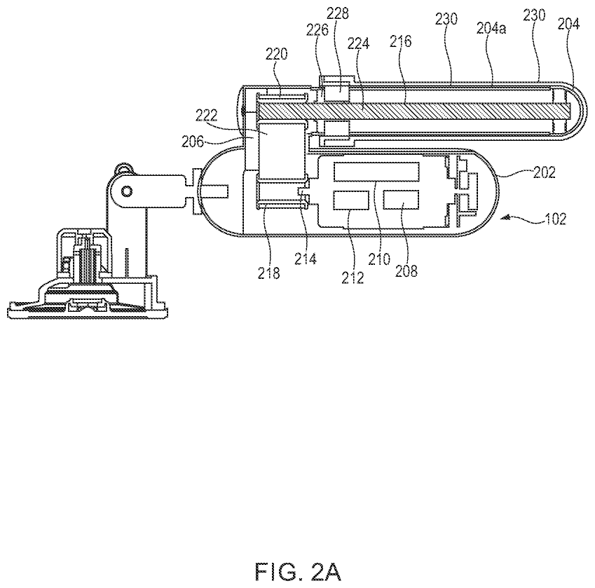

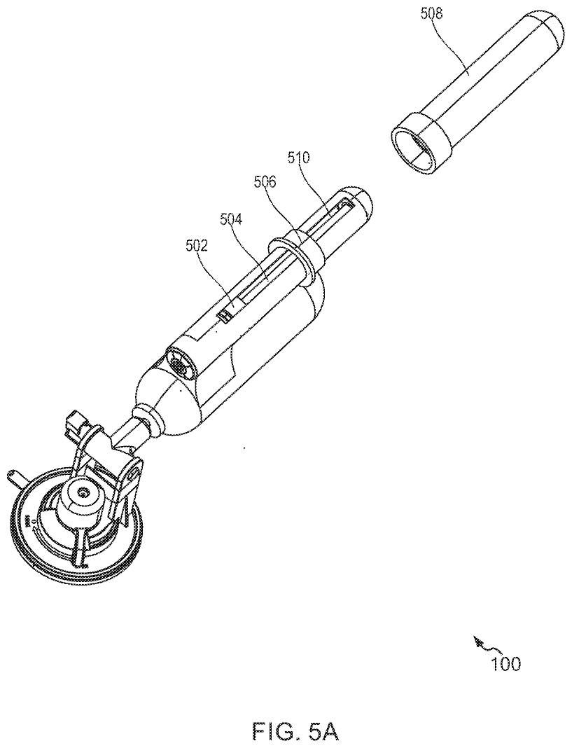

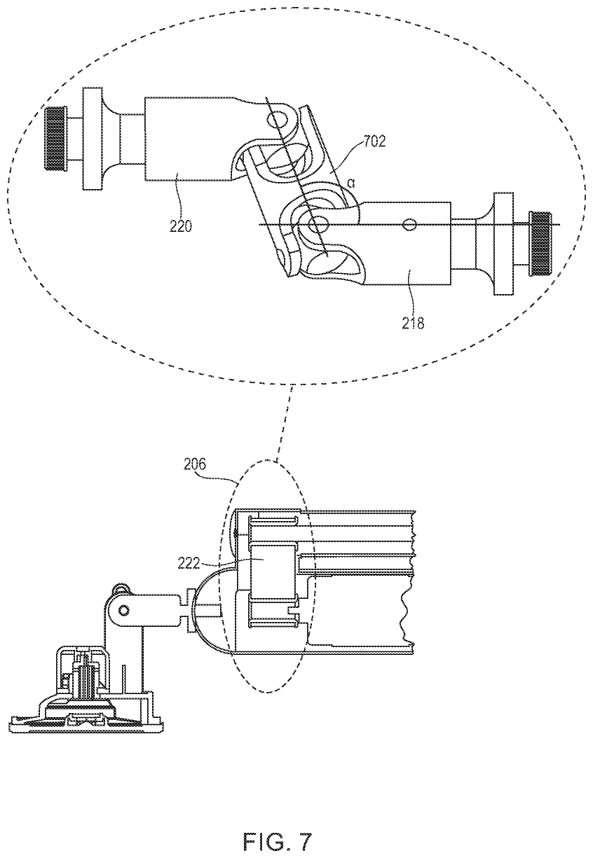

The sexual stimulation adult massager 100 includes a hollow housing 102, a motor assembly 104, a transmission structure 106, a sliding assembly 108, a movement structure 110, and a connecting assembly 112. The hollow housing 102 has a slot 114 provided in an outer shell 116 of the hollow housing 102. The transmission structure 106 is provided inside the hollow housing 102 to be operatively driven by the motor assembly 104 disposed within the hollow housing 102 to produce a rotational motion 118 to the transmission structure 106. The sliding assembly 108 is adapted to be disposed on the transmission structure 106 for converting the rotational motion 118 of the transmission structure 106 into a reciprocating motion 120 of the sliding assembly 108. The movement structure 110 is operatively connected to the sliding assembly 108 through the slot 114 for achieving the reciprocating motion 120. The movement structure 110 includes a connecting assembly 112 to be adapted to connect to an adult toy 122 to provide sexual stimulation to a user due to the reciprocating motion 120. The reciprocating motion 120 of the movement structure 110 is achieved with the help of various mechanical linkages which are explained in further detail in FIG. 2A, FIG. 5A and FIG. 5B or with the help of a linear motor 802 (See FIG. 8) of the motor assembly 104 which is explained in further detail in FIG. 8. The stroke length of the adult toy 122 depends on the distance of movement of the sliding assembly 108. The hollow housing 102 may come in different shapes and configurations. In one embodiment, the cross-section of the hollow housing 102 is selected from a group essentially consisting of a rectangle, square, circle, or polygon. The motor assembly 104 may include an AC (Alternating Current) motor or DC (Direct Current) motor. The AC motor is run by a power source 208 (See FIG. 2A) whereas the DC motor is run by a battery.

FIG. 2A illustrates a schematic representation of an internal configuration of a sexual stimulation adult massager in a contracted condition, in accordance with an embodiment of the present disclosure. The hollow housing 102 includes a first hollow tube 202 and a second hollow tube 204 adapted to be coupled to the first hollow tube 202 through a connecting portion 206 disposed in the first hollow tube 202 and the second hollow tube 204. The motor assembly 104 includes a power source 208, a controller 210, a motor 212, and a motor rotating shaft 214. The power source 208 is coupled to the motor 212 through the controller 210. The power source 208 is configured to provide electrical power to the motor 212 utilized for providing rotation to the motor rotating shaft 214. The power source 208 is capable of providing alternating current (AC) or a direct current (DC) as per the configuration of the motor 212. In another configuration, the power source 208 may be a battery (e.g., a lithium-ion battery) to drive the motor 212. The controller 210 controls the power supply to the motor 212. Based on regulating the power supply to the motor 212, the rotational speed of the motor 212 can be changed. In an example, the controller 210 regulates a voltage or a current supplied to the motor 212, which in turn regulates the rotational speed of the motor 212.

The transmission structure 106 includes a screw rod 216, an active wheel 218, a driven wheel 220, and a transmission part 222. The active wheel 218 is configured in the first hollow tube 202 and operatively connected to the motor rotating shaft 214 of the motor 212. The driven wheel 220 is configured in the second hollow tube 204 and operatively connected to the active wheel 218 through the transmission part 222 provided in the connecting portion 206 of the first hollow tube 202 and the second hollow tube 204. The screw rod 216 configured in the second hollow tube 204 is operatively connected to the driven wheel 220. The screw rod 216 may be provided with different types of grooves such as acme, square, buttress, helical or spiral, and the like. In one embodiment, the screw rod 216 is provided with a spiral groove 224 which may be a bi-directional spiral groove or a unidirectional spiral groove.

The sliding assembly 108 includes a screw slider 226 coupled to the screw rod 216. The screw slider 226 is of L-shaped cross-section. The connecting assembly 112 of the movement structure 110 includes a ring slider 228 and a first tubular fixed seat 230. The ring slider 228 has L-shaped cross-section and is adapted to pass through the screw rod 216 to mate against the screw slider 226. The ring slider 228 has a slot extending therethrough to accommodate an upper portion 204a of the second hollow tube 204, wherein the upper portion 204a of the second hollow tube 204 is adapted to mate with the connecting portion 206 of the second hollow tube 204. The first tubular fixed seat 230 is detachably coupled to the ring slider 228. The sliding assembly 108 and the connecting assembly 112 lie proximal to the driven wheel 220 in contracted condition as shown in FIG. 2A. In one embodiment, the motor rotating shaft 214 and the screw rod 216 configured in the first hollow tube 202 and the second hollow tube 204 respectively are held parallel to each other.

FIG. 2B illustrates a schematic representation of the internal configuration of the sexual stimulation adult massager of FIG. 2A in an expanding condition. In the expanding condition, a rotational motion 232 of the screw rod 216 is converted into a translation motion 234 of the screw slider 226 which in turn pushes the ring slider 228. The ring slider 228 moves along the screw rod 216 and finally hits a stopper 236 located at one end of the second hollow tube 204 restricting further translation motion 234 of the screw slider 226 thereby producing a reciprocating motion 238 of the screw slider 226 along the screw rod 216 due to creation of opposite force. The reciprocating motion 238 of the screw slider 226 is between the driven wheel 220 and the stopper 236. In one embodiment, the screw rod 216 and the screw slider 226 are designed in the form of a lead screw. In another embodiment, the screw rod 216 and the screw slider 226 are designed in the form of a ball screw. In one configuration, the screw rod 216 and the screw slider 226 are provided with a lubrication mechanism to reduce friction during the reciprocating motion 238. In one example, the pitch of the spiral groove 224 of the screw rod 216 is about 5 mm to 10 mm providing substantially shorter translation motion 234 of the screw slider 226 for one rotation of the screw rod 216. In another example, the pitch of the spiral groove 224 of the screw rod 216 is about 10 mm to 20 mm providing a substantially larger translation motion 234 of the screw slider for one rotation of the screw rod 216.

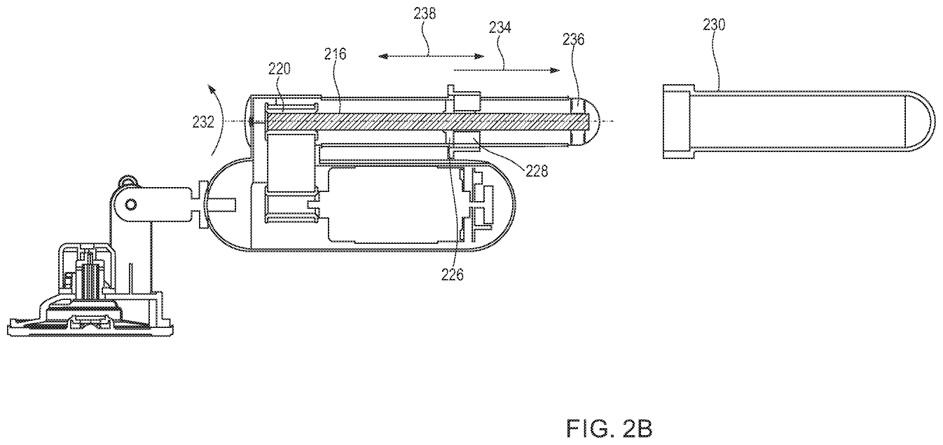

FIG. 3 illustrates a schematic representation of an arrangement of a motor assembly and a transmission structure along the same axis, in accordance with an embodiment of the present disclosure. In this embodiment, a motor rotating shaft 302 of a motor 304 is coupled to a screw rod 306 along a longitudinal axis 308. Some examples of the coupling used to couple the motor rotating shaft 302 with the screw rod 306 may include a flange coupling, a sleeve coupling, a flexible coupling, a universal coupling, and the like. The coupling geometry can be defined by considering an installation error such as angular misalignment, lateral misalignment, etc., and mechanical flexibility while coupling the motor rotating shaft 302 with the screw rod 306. The coupling also provides mechanical flexibility and tolerance for shaft misalignments. In another embodiment, the motor rotating shaft 302 may be coupled to the screw rod 306 using one of a power transmission mechanisms such as a gearbox arrangement, a belt drive arrangement, a chain drive arrangement, and the like. In one example, the gearbox containing a set of gears provides a sturdy connection, an increased torque, and a velocity ratio as per the user's need. In addition, the motor rotating shaft 302 and the screw rod 306 may be oriented in different directions. In one scenario, the gearbox having a bevel gear connects the shafts whose axes lie at a right angle with each other.

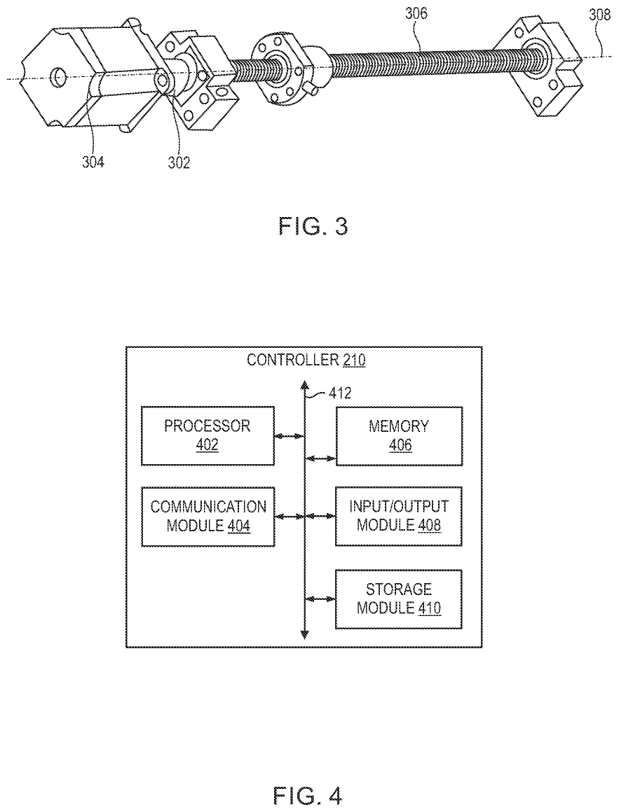

FIG. 4 is a block diagram of a controller for controlling the operation of one or more components of a sexual stimulation massage apparatus, in accordance with an embodiment of the present disclosure. The controller 210 includes a processor 402, a communication module 404, a memory 406, an input/output module 408, and a storage module 410. The memory 406 is configured to store mechanism-executable instructions. The processor 402 may be a single-core processor, a multi-core processor, and/or any combination thereof. The memory 406 may include one or more volatile memory devices, one or more non-volatile memory devices, and/or any combination thereof. In one embodiment, the memory 406 stores logic and/or instructions that are to be used by processor 402 for controlling the motor 212. In one example, the motor 212 is a unidirectional motor. In another example, the motor 212 is a reversible motor.

FIG. 5A illustrates a perspective view of a sexual stimulation adult massager, in accordance with an embodiment of the present disclosure. In one embodiment, the sexual stimulation adult massager 100 includes a screw slider 502, a screw rod 504, a ring slider 506, and a first tubular fixed seat 508. The screw slider 502 is operatively connected to the screw rod 504 and projects out of a slot 510 provided in the second hollow tube 204. The ring slider 506 is a hollow cylinder provided with a circular base. In one embodiment, the ring slider 506 provided with a keyway slot on its inner diameter is adapted to insert over the second hollow tube 204 to mate with the screw slider 502. In another embodiment, the screw slider 502 is provided with a keyway slot on its upper surface and the ring slider 506 provided with a key on its inner diameter is adapted to insert over the second hollow tube 204 to mate with the keyway slot of the screw slider 502. The first tubular fixed seat 508 is adapted to fit over the ring slider 506 by means of a snap-fit, clamp fit, or a fastener.

FIG. 5B illustrates a perspective view of a sexual stimulation adult massager, in accordance with another embodiment of the present disclosure. In another embodiment, the sexual stimulation adult massager 100 includes a connector 512, a screw slider 514 and a second fixed seat 516. In one embodiment of the invention, the second fixed seat 516 may be tubular in shape. In several alternate embodiments, the shape of the second fixed seat 516 may not be limited to a tubular shape and the second fixed seat 516 may take other shapes such as a shape of a plate. In one configuration, the connector 512 is integrally formed over the screw slider 514 and the second fixed seat 516 provided with a keyway slot 518 is adapted to be inserted or slid, depending upon the shape of the second fixed seat 516, over the second hollow tube 204 to mate with the connector 512 of the screw slider 514. The keyway slot 518 may be provided on an inner diameter of the second fixed seat 516 when the second fixed seat 516 is tubular in shape. In the embodiments where the shape of the second fixed seat 516 is in form of a plate, the keyway slot 518 may be provided on the bottom surface of the second fixed seat 516. In that manner, the location of the keyway slot 518 may vary depending upon the shape of the second fixed seat 516 and enable the mating of the second fixed seat 516 with the connector 512 of the screw slider 514. In another configuration, the connector 512 is coupled over the screw slider 514 and the second fixed seat 516 provided with the keyway slot 518 is adapted to be inserted or slid over the second hollow tube 204 to mate with the connector 512 of the screw slider 514. In one scenario, the connector 512 is coupled over the screw slider 514 through a pin arrangement. In another scenario, the connector 512 is coupled over the screw slider 514 by means of a keyway arrangement.

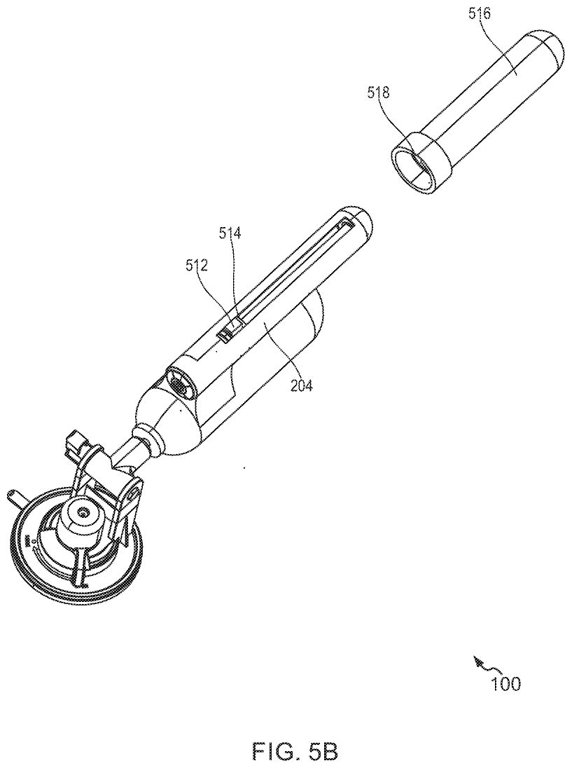

FIG. 6 illustrates a schematic representation of the operation of a screw slider of the sexual stimulation adult massager of FIGS. 5A and 5B. The screw slider (502, 514) of the sexual stimulation adult massager 100 is operatively connected to the screw rod 504 by means of a crescent plate 602, and the screw slider (502, 514) is adapted to project out of the slot 510 provided in the second hollow tube 204. The screw rod 504 is configured to rotate in a clockwise direction or anti-clockwise direction 604 with respect to a pre-specified rotation of the motor rotating shaft 214 of the motor 212. The rotation of the screw rod 504 is converted into a reciprocating motion 606 of the screw slider (502, 514) through the crescent plate 602. As shown, the screw rod 504 is cylindrical in shape and formed with a bidirectional thread 608. The bidirectional thread 608 is configured to provide a channel for the movement of the crescent plate 602. The crescent plate 602 is a piece of metal that accommodates at least a portion of the bidirectional thread 608 of the screw rod 504. The geometrical profile of the crescent plate 602 is designed considering a clearance fit between bidirectional thread 608 of the screw rod 504 and the crescent plate 602. The crescent plate 602 easily slides within the bidirectional thread 608 of the screw rod 504 without jamming or sticking the surfaces. The head of the crescent plate 602 is attached to the screw slider (502, 514) using a pin 610. In other words, the screw slider (502, 514) is in engagement with the screw rod 504 via the crescent plate 602 that is slidably positioned in the bidirectional thread 608 of the screw rod 504. In one scenario, the bidirectional thread 608 of the screw rod 504 is a continuous thread and formed as bidirectional. The thread profile may be designed to transmit maximum torque with the least loss. In another scenario, the thread is a continuous thread formed of a left-hand helical groove and a right-hand helical groove connected to one another at either end of the screw rod 504 for providing sliding movement to the screw slider (502, 514). Alternatively, a spiral thread may be formed on the screw rod 504.

In another embodiment, the motor rotating shaft 214 of the motor 212 may be fabricated with the bidirectional thread 608 eliminating the need for the screw rod 504. The bidirectional thread 608 provided on the motor rotating shaft 214 produces the reciprocating motion 606 to the screw slider (502, 514) through the crescent plate 602. The reciprocation frequency of the screw slider (502, 514) adapted to operate the connecting assembly 112 is directly proportional to the speed of rotation of the motor rotating shaft 214 of the motor 212.

The speed of rotation of the motor rotating shaft 214 of the motor 212 is controlled by the controller 210.

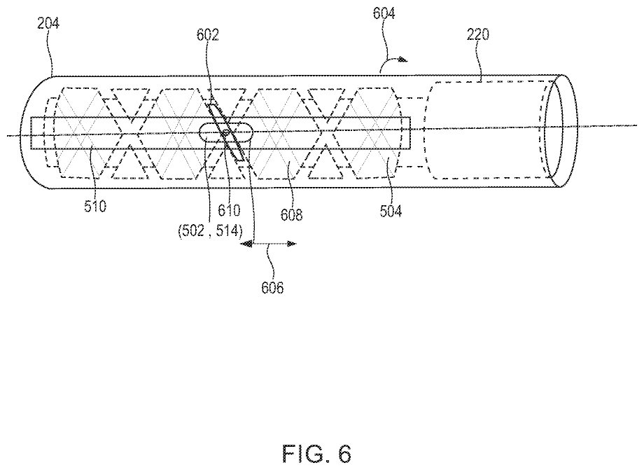

FIG. 7 illustrates a schematic representation of a transmission part of a sexual stimulation adult massager, in accordance with another embodiment of the present disclosure. The transmission part 222 configured in the connecting portion 206 includes a universal coupling, a belt, a gear, or a chain arrangement coupled in between the active wheel 218 and the driven wheel 220. A universal coupling 702 disposed in the connecting portion 206 facilitates in an adjustment of an angle α between the first hollow tube 202 and the second hollow tube 204 by rotation of the connecting portion 206. The changing of the angle α between the first hollow tube 202 and the second hollow tube 204 facilitates the adult toy 122 in reaching out to various portions of the vagina (like G-spot) or penis located at different angles thereby providing maximum sexual stimulation effect to the user.

FIG. 8 illustrates a schematic representation of a motor assembly of a sexual stimulation adult massager, in accordance with another embodiment of the present disclosure. In one embodiment, the motor assembly 104 includes a linear motor 802. The linear motor 802 further includes at least one coil assembly 804, a reaction plate 806, and a power supply 808. The coil assembly 804 consists of a plurality of three-phase coils wound and inserted into a steel lamination stack. The reaction plate 806 is made up of aluminum or copper provided with a steel backing. The reaction plate 806 is mounted on a plurality of bearings thereby maintaining an air gap between the reaction plate 806 and the coil assembly 804. The power supply 808 supplies AC power to the coil assembly 804 which induces a traveling electromagnetic flux wave moving relative to the coil assembly 804. The travelling electromagnetic flux wave induces electric current in the reaction plate 806 which further interacts with the traveling electromagnetic flux to produce a linear motion 810 in the reaction plate 806. The movement structure 110 is operatively connected to the reaction plate 806 for achieving the reciprocating motion 120. In another embodiment, the reaction plate 806 is provided between one pair of coil assemblies 804, and each of the coil assemblies is supplied with the power supply 808. The reaction plate 806 is made up of aluminum or copper only. The stroke of the movement structure 110 depends on a stroke length 812 of the reaction plate 806. In one configuration, the stroke length 812 of the reaction plate 806 includes about 40 mm to 60 mm.

In one form, the reaction plate 806 is mounted on the plurality of bearings disposed at least at each end of the reaction plate 806. Each of the bearings is integrated with a pedestal assembled over the reaction plate 806. The pedestal includes a bearing housing for accommodating the plurality of bearings configured to support the reaction plate 806. The plurality of bearings used for supporting the reaction plate 806 may be one of roller bearings, ball bearings, journal bearings, or magnetic bearings. The plurality of bearings is configured to support the load of the reaction plate 806. Also, the plurality of bearings is designed to eliminate friction and vibration generated during the operation of the reaction plate 806.

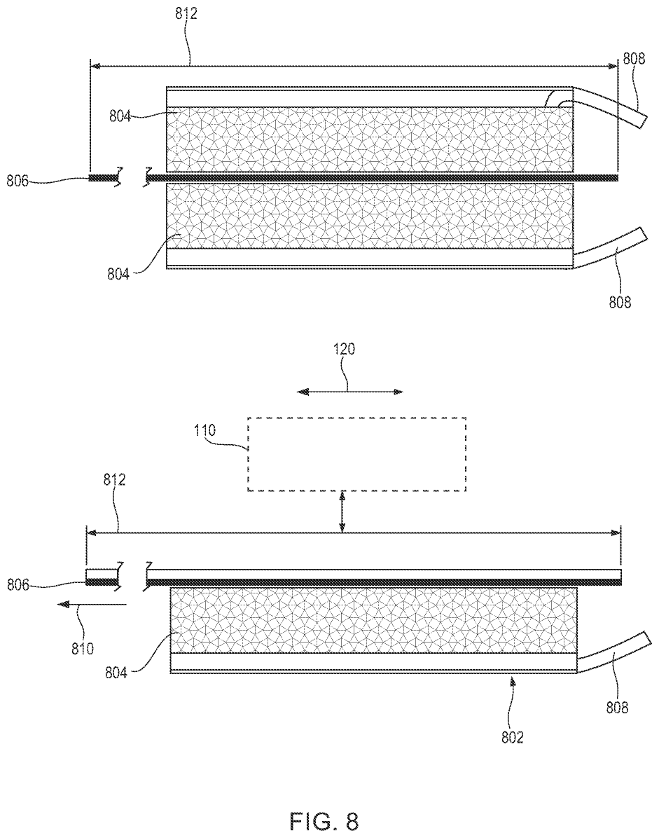

FIG. 9 illustrates a schematic representation of a mounting structure of a sexual stimulation adult massager, in accordance with another embodiment of the present disclosure. The mounting structure 900 includes a connecting rod 902, a base 904, a rotating shaft 906 and a suction cup 908. One end of the connecting rod 902 is adapted to couple to the first hollow tube 202 and the other end of the connecting rod 902 is coupled to the rotating shaft 906 of the base 904 in a fixed condition. In one embodiment, the rotation of the rotating shaft 906 along its axis 910 facilitates the movement of the connecting rod 902 in an up and down direction 912. In another embodiment, the rotation of the base 904 along an axis 914 facilitates the movement of the connecting rod 902 in an angular direction 916. The base 904 is provided with the suction cup 908 to mount the sexual stimulation adult massager 100 firmly on any fixed platform. In one embodiment, the base 904 of the sexual stimulation adult massager 100 is mounted firmly on any fixed platform through fastening means. In another embodiment, the base 904 with the suction cup 908 is coupled directly to the hollow housing 102 or the first hollow tube 202 of the sexual stimulation adult massager 100 to be adapted to mount firmly on any fixed platform. Alternatively, the hollow housing 102 or the first hollow tube 202 of the sexual stimulation adult massager 100 is provided with a holder to be held in the user's palm while in operation. In one configuration, the holder may be formed with grooves, textures, cross patterns, or a combination thereof to provide a frictional effect to the user's palm during holding. The gripping surface assists in eliminating the chances of slippage from the user's palm.

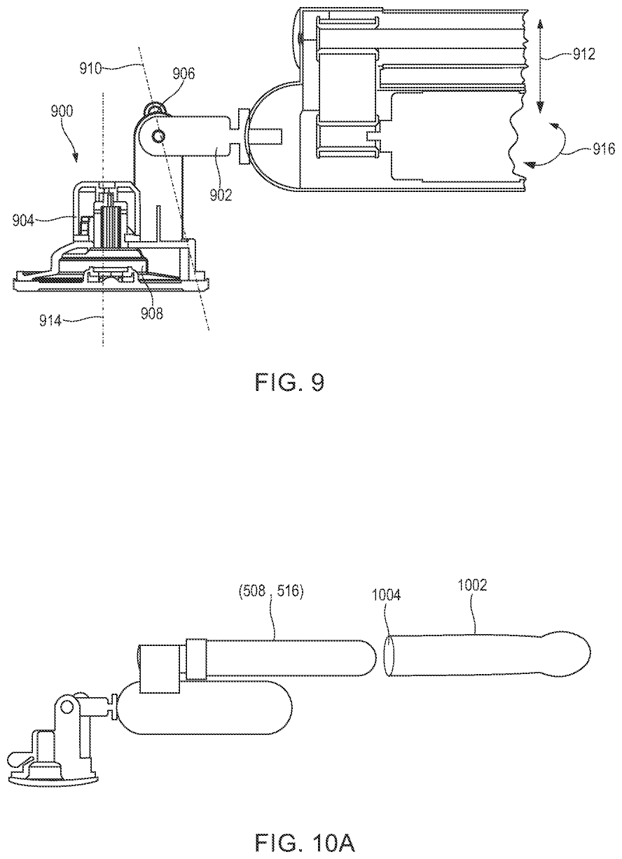

FIGS. 10A and 10B illustrate a schematic representation of mounting an adult toy on a sexual stimulation adult massager, in accordance with another embodiment of the present disclosure. The adult toy 1002 is a dildo provided with a hole 1004 complementary to mate with the first tubular fixed seat 508 or the second fixed seat 516 of the sexual stimulation adult massager 100. The adult toy 1002 mated onto the first tubular fixed seat 508 or the second fixed seat 516 resembles the shape of a penis and provides sexual stimulation to the vulva, clitoris, and vagina of the female body. In one embodiment, the adult toy 1002 is a flexible body. In another embodiment, the adult toy 1002 is a solid body. The adult toy 1002 is made up of medical-grade material like silicone, glass, or metal. In one configuration, the adult toy 1002 is provided with textured surfaces such as dots, ribs, ridges, and the like to enhance sexual stimulation to the vagina of the female body. In one example, the adult toy 1002 is provided with pores to dispense lubricating liquid or sexual arousal medicated liquid.

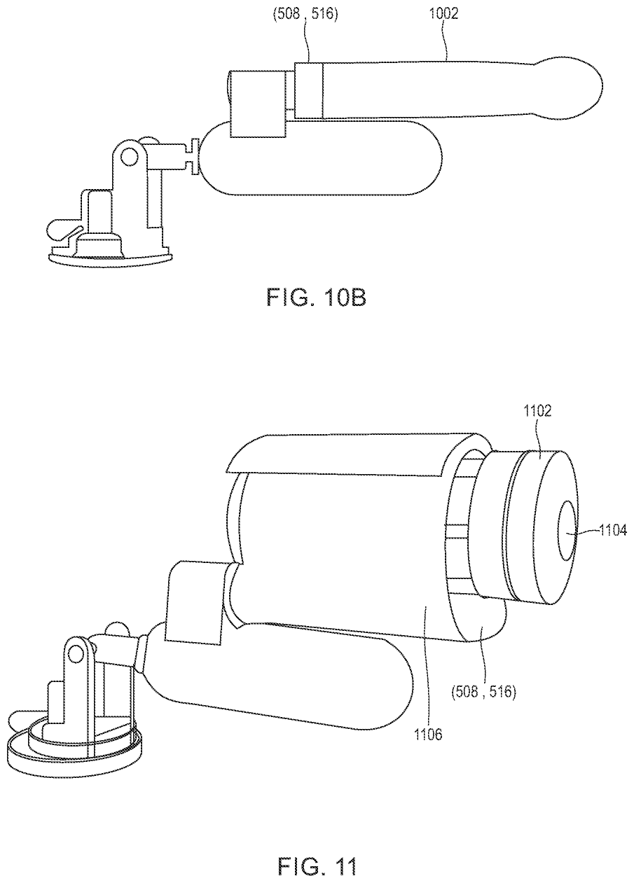

FIG. 11 illustrates a schematic representation of mounting an adult toy on a sexual stimulation adult massager, in accordance with another embodiment of the present disclosure. The adult toy 1102 is a suction cup provided with a hole 1104 therein to accommodate a penis. The adult toy 1102 is coupled to the first tubular fixed seat 508 or the second fixed seat 516 of the sexual stimulation adult massager 100 by means of a clamping structure 1106. In one scenario, the adult toy 1102 is provided with pores on its inner diameter to dispense lubricating liquid or sexual arousal medicated liquid.

Various embodiments of the disclosure, as discussed above, may be practiced with steps and/or operations in a different order, and/or with hardware elements in configurations, which are different from those which are disclosed. Therefore, although the disclosure has been described based on these exemplary embodiments, it is noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A sexual stimulation adult massager, comprising:
a hollow housing having a slot provided in an outer shell of the hollow housing;
a motor assembly disposed within the hollow housing;
a transmission structure provided inside the hollow housing configured to be operatively driven by the motor assembly;
a sliding assembly operatively connected with the transmission structure to convert a rotational motion of the transmission structure into a reciprocating motion of the sliding assembly; and
a movement structure operatively connected with the sliding assembly through the slot for achieving the reciprocating motion, wherein the movement structure comprises a connecting assembly configured to connect to an adult toy to provide sexual stimulation to a user due to the reciprocating motion of the movement structure.

2. The sexual stimulation adult massager as claimed in claim 1, wherein the transmission structure comprises a screw rod having a spiral groove, operatively connected to a motor rotating shaft of a motor of the motor assembly.

3. The sexual stimulation adult massager as claimed in claim 2, wherein the sliding assembly comprises a screw slider coupled to the screw rod of the transmission structure to convert the rotational motion of the screw rod into the reciprocating motion of the screw slider.

4. The sexual stimulation adult massager as claimed in claim 2, wherein the transmission structure further comprises:
an active wheel operatively connected to the motor rotating shaft of the motor; and a driven wheel operatively connected to the active wheel through a transmission part and set in parallel to the active wheel, wherein the screw rod operatively connected to the driven wheel rotates by operation of the active wheel.

5. The sexual stimulation adult massager as claimed in claim 4, wherein the transmission part comprises a belt, a gear or a universal coupling.

6. The sexual stimulation adult massager as claimed in claim 2, wherein the spiral groove of the screw rod is a bi-directional spiral groove or a unidirectional spiral groove.

7. The sexual stimulation adult massager as claimed in claim 2, wherein the motor is a unidirectional motor or a reversible motor.

8. The sexual stimulation adult massager as claimed in claim 1, wherein the motor assembly comprises a linear motor adapted to connect to the movement structure to produce the reciprocating motion.

9. The sexual stimulation adult massager as claimed in claim 8, wherein the linear motor comprises at least one coil assembly, a reaction plate, and a power supply.

10. The sexual stimulation adult massager as claimed in claim 9, wherein the reaction plate is adapted to operatively couple to the at least one coil assembly.

11. The sexual stimulation adult massager as claimed in claim 10, wherein the movement structure is the reaction plate.

12. The sexual stimulation adult massager as claimed in claim 1, further comprising a connecting rod with one end coupled to the hollow housing and other end coupled to a rotating shaft of a base.

13. The sexual stimulation adult massager as claimed in claim 12, wherein the base comprises a suction cup.

14. A sexual stimulation adult massager, comprising:
a hollow housing including a first hollow tube and a second hollow tube, wherein the second hollow tube includes a slot provided in an outer shell of the second hollow tube, wherein the second hollow tube is adapted to connect to the first hollow tube through a connecting portion disposed in the first hollow tube and the second hollow tube;
a transmission structure including an active wheel provided in the connecting portion of the first hollow tube and a driven wheel provided in the connecting portion of the second hollow tube, wherein the active wheel is adapted to couple to a motor assembly disposed in the first hollow tube and the driven wheel is adapted to couple to the active wheel through a transmission part, wherein the transmission structure includes a screw rod disposed in the second hollow tube to be operatively coupled to the driven wheel; and
a sliding assembly includes a screw slider operatively coupled to the screw rod, wherein the screw slider is adapted to connect to a connecting assembly.

15. The sexual stimulation adult massager as claimed in claim 14, wherein the connecting assembly comprises:
a connector coupled to the screw slider disposed in the slot of the second hollow tube; and
a second fixed seat adapted to couple to the connector projecting outside the second hollow tube, wherein the second fixed seat is adapted to connect to the adult toy.

16. The sexual stimulation adult massager as claimed in claim 15, wherein the connecting assembly comprises:
a ring slider adapted to couple to the screw slider with the second hollow tube encompassed therein; and
a first tubular fixed seat adapted to detachably couple to the ring slider, wherein the first tubular fixed seat is configured to connect to an adult toy.

17. The sexual stimulation adult massager as claimed in claim 14, wherein the transmission part comprises a universal coupling disposed in the connecting portion to be adapted to adjust an angle between the first hollow tube and the second hollow tube by rotation of the connecting portion.

18. The sexual stimulation adult massager as claimed in claim 16, wherein the adult toy is a suction cup adapted to connect to the first tubular fixed seat or the second fixed seat by a clamping structure.

19. The sexual stimulation adult massager as claimed in claim 16, wherein the adult toy is a dildo provided with a hole to be adapted to connect to the first tubular fixed seat or the second fixed seat.

20. The sexual stimulation adult massager as claimed in claim 14, wherein the screw slider is operatively coupled to the screw rod through a crescent plate.
